(19) United States
(12) Patent Application Publication
(10) Pub. No.: US 2021/0357915 A1
(43) Pub. Date: Nov. 18, 2021

(54) METHODS, DEVICES, AND SYSTEMS FOR SECURE PAYMENTS

(71) Applicant: Tunnel International Inc., Boston, MA (US)

(72) Inventor: Frank Makrides, Belmont, MA (US)

(21) Appl. No.: 17/388,354

(22) Filed: Jul. 29, 2021

Related U.S. Application Data
(63) Continuation of application No. PCT/US19/68904, filed on Dec. 30, 2019.

(51) Int. Cl. G06Q 20/36; G06Q 20/40; G06Q 20/38; G06Q 20/02; G06Q 20/32; G06Q 20/06; G06Q 20/10

(52) U.S. Cl. CPC G06Q 20/3674; G06Q 20/40145; G06Q 20/4012; G06Q 20/108; G06Q 20/023; G06Q 20/3276; G06Q 20/0655; G06Q 20/3825

(57) ABSTRACT

Disclosed herein are methods, systems, and devices for solving the technological problem of security within centralized payment systems using hybrids of cryptographically secure distributed ledger technologies and centralized payment systems. In one embodiment, a computer-based system is configured for payments using a hybrid architecture of a centralized payment system and a cryptographically secure distributed ledger technology. The computer-based system includes a centralized database, a distributed ledger, application programming interfaces (API) servers, users' devices (including customer devices and merchant devices), and a master wallet device.

### PRIORITY CLAIM

This application is a continuation of International Patent Application No. PCT/US2019/068904 entitled “METHODS, DEVICES, AND SYSTEMS FOR SECURE PAYMENTS”, filed Dec. 30, 2019, the disclosure of which is incorporated herein by reference in its entirety.

### TECHNICAL FIELD

The present disclosure generally relates to cryptocurrencies and payment systems. More specifically, the disclosure applies to security within cryptocurrencies and centralized payment systems.

### BACKGROUND

Digital assets and/or cryptocurrencies, like Bitcoin, are too volatile to be widely adopted as a payment system and be accepted by major merchants. If a cryptocurrency is used to pay for goods and/or services, its exchange rate to USD (or other fiat currency) may significantly change by the end of the day and the merchant risks losing money.

There is a class of cryptocurrencies called stable coins. Stable coins are aimed to solve the volatility problem. These systems may have a cost to support stability. Transactions to send coins may not be free and/or they may not conceal the balance. They may still deviate from the pegged currency by a few percent. Additionally, they may have a risk of a “black swan” event and they may have scalability problems.

Another issue for cryptocurrencies to be accepted by major merchants is regulatory risks. For example “Know Your Customer” (KYC) and “Anti-Money Laundering” (AML) rules may not be followed by such systems.

On the other side, traditional centralized payments charge fees as high as 2.9% or more, to process payments. A technological issue with these systems is security. Due to their centralized architecture, they have a single point of attack. When hacked, the centralized architecture may lead to compromising all users' data and may also include loss of money.

Accordingly, a need exists for new methods, systems, and devices for improving security within cryptocurrencies and centralized payment systems.

### SUMMARY

Disclosed herein are methods, systems, and devices for solving the technological problem of security within centralized payment systems using a hybrids of cryptographically secure distributed ledger technologies and centralized payment systems.

In one embodiment, a computer-based system is configured for payments using a hybrid architecture of a centralized payment system and a cryptographically secure distributed ledger technology. The computer-based system includes a centralized database, a distributed ledger, application programming interfaces (API) servers, users' devices (including customer devices and merchant devices), and a master wallet device.

The computer-based system is configured to provide a method. The method includes (1) registering, by the processor, by the user device and by the connected API node/server, in the device application by capturing the input from the user (Customer or Merchant), such as the email and application password, the phone number, multi-factor authentication (such as biometric data, pin, etc.), and processing the data; (2) generating, by the processor, by the user device, a pair of public/private keys for the digital wallet; (3) encrypting, by the processor, by the user device, the private key with the wallet password, entered by the user, and, optionally, securely backup the private key to be able to restore in case of device lost and/or forgetting the password; (4) connecting, by the processor and network interface, to KYC verification module to verify the client identity; (5) connecting, by the processor and network interface, to Bank account ownership verification module to make sure that the person or entity owns the bank account that will be used to deposit and withdraw fiat currency; (6) processing, by the processor, by the API node, the Customer's fiat currency deposit request by using the bank API, ACH network or other means to make inter-bank transfers; (7) processing, by the processor, by the API Node, distributed ledger, user device and master wallet device, the transfer of digital assets from the Payment System master wallet to the client wallet; (8) generating the invoice, by the processor, by the Merchant's device, for the Customer to pay, by generating a QR code or the like; (9) generating the Customer's part of the transaction, by the processor, by the Customer's device, by processing the invoice (such as scanning QR code), getting the Merchant's wallet address, amount to pay and other data, creating the sender block and signing by the wallet private key and sending to the distributed ledger; (10) generating the Merchant's part of the transaction, by the processor, by the Merchant's device, by creating the receiver block and signing by the wallet private key to accept the incoming transfer and sending to the distributed ledger; (11) processing, by the processor, by individual servers in distributed ledger the transaction and agree with other servers to accept or reject it; (12) processing, by the processor, by the API node, the client's fiat currency withdrawal request by using the bank API, ACH network or other means to make inter-bank transfers; and (13) processing, by the processor, by the API Node, distributed ledger, user device and master wallet device, the transfer of digital assets from the client wallet to Payment System master wallet.

In some embodiments, the computer-based system may include a memory having a Confidential Multi-chain computer-based memory structure for computing nodes in the distributed ledger. The memory includes a set of chains stored in the memory, wherein each chain represents an individual account and tracks balance changes with (or without) privacy.

In some embodiments, the computer-based system may include methods that include (1) verifying, by the processor, by the validating node, the signatures of all transaction data blocks, to make sure data has not been changed by the attacker; (2) verifying, by the processor, by the validating node, all commitment values and zero-knowledge proofs, to make sure that the attacker did not change the balances; (3) concealing the balances, by the processor, by the user device using the user private keys; and (4) sending, by the processor and network interface, by the user device the account head block with account history to the server to restore the whole ledger and/or verify customer's balance, for example in case of catastrophic event of complete data lost on the server.

In one embodiment, a computer-based system is configured for cost effective deposit and withdraw of fiat currency into and from the system with conversion to digital assets. The computer-based system includes a centralized database, distributed ledger, API nodes/servers, a user device, a master wallet device;

The computer-based system is configured to provide a method including (1) registering, by the processor, by the user device and by the connected API node/server, in the device application by capturing the input from the user, such as the email and application password, the phone number, multi-factor authentication (such as biometric data, pin, etc.), and processing the data; (2) generating, by the processor, by the user device, a pair of public/private keys for the digital wallet; (3) encrypting, by the processor, by the user device, the private key with the wallet password, entered by the user, and, optionally, securely backing up the key to be able to restore in case of device lost and/or forgetting the password; (4) connecting, by the processor and network interface, to KYC verification module to verify the client identity; (5) connecting, by the processor and network interface, to Bank account ownership verification module to make sure that the person or entity owns the bank account that will be used to deposit and withdraw fiat funds; (6) processing, by the processor, by the API node, the Customer's fiat fund deposit request by using the bank API, ACH network or other means to make inter-bank transfers; (7) initiating, by the processor, by the API Node, the transfer of digital assets from the Payment System master wallet to the client wallet; (7) generating the sender's part of the transaction, by the processor, by the Master wallet device, the sender block and signing by the wallet private key and sending to the distributed ledger; (8) generating the receiver's part of the transaction, by the processor, by the user device, by creating the receiver block and signing by the wallet private key to accept the incoming transfer and sending to the distributed ledger; (9) processing, by the processor, by individual servers in distributed ledger the transaction and agree with other servers to accept or reject it, and notifying the participants; (10) processing, by the processor, by the API node, the client's fiat currency withdrawal request by using the bank API, ACH network or other means to make inter-bank transfers; and (11) processing, by the processor, by the API Node, distributed ledger, user device and master wallet device, the transfer of digital assets from the client wallet to Payment System master wallet.

In another embodiment, a computer-based system is configured for a method of reaching consensus between computing devices to accept or reject the transaction when all the balances are encrypted. The computer-based system includes distributed ledger with a set of computing nodes (validating nodes) and users' devices. The method includes (1) generating, by the processor, by the user device, a pair of public/private keys for the digital wallet; (2) registering, by the processor and network interface, of the computing node as a validating node by keeping at least as much assets as the minimum balance threshold of digital assets, locking the assets for a long period of time; (3) generating, by the processor, by the validating node, zero-knowledge proof that the node has at least as much assets as the minimum balance threshold without revealing the total balance; (4) registering, by the processor and network interface, by the user device all the validating nodes in the system to count total votes by downloading the accounts of all validating nodes and validating the zero-knowledge proof that they have at least as much assets as the minimum balance threshold and that assets are locked; (5) registering, by the processor, by every validating node the total number and the list of all other validating nodes in the system by searching in the ledger and validating the zero-knowledge proof that they have at least as much assets as the minimum balance threshold and that the assets locked; (6) counting, by the processor, by all network participants the number of votes in the system as the total number of valid validating nodes; (7) generating the sender's part of the transaction, by the processor, by the sender's user device, by creating the sender block and signing by the wallet private key and sending to the distributed ledger; (8) generating the receiver's part of the transaction, by the processor, by the receiver's user device, by creating the receiver's block and signing by the wallet private key to accept the incoming transfer and sending to the distributed ledger; (9) processing, by the processor, by individual validating nodes in distributed ledger the transaction and agree with other servers to accept or reject it using byzantine fault tolerant protocol, and notifying the participants by sending from each validating node a cryptographically signed vote; (10) receiving, by the processor and network interface, by the sender and receiver the signed votes from the validating nodes and counting whether enough number of nodes voted to accept the transaction and thus deciding if settlement happened; (11) verifying and tracking, by the processor, by network nodes, signatures of validating nodes and detecting malicious nodes, banning such nodes from participating in consensus and forfeiting their stake; and (12) validating, by the processor, by validating nodes that a validating node that decided to stop staking and withdraw the stake, cannot participate in consensus nor transfer assets until a long silence period ends.

In another embodiment, a computer-based system is configured for a method of secure backup of wallet private keys to and from a centralized system, comprising. The computer-based system includes a user device (for example, mobile phone, tablet, PC, etc.) and a server with storage (for example, a database). The method includes (1) encrypting, by the processor, by the user device, the private key with the password entered by the user and validate by the system; (2) capturing, by the processor and storing temporary in RAM memory, by the user device, three security questions that user selected and/or typed by himself/herself and answers to these questions; (3) encrypting, by the processor, by the user device, private key password using the encryption key based on the answers to security questions; (4) encrypting, by the processor, by the user device, the security questions using the encryption key based on the combination of personal data (for example: SSN, account number, driver's license, etc.); (5) sending, by the user device using network interface, to the centralized server encrypted private key, encrypted password to the private key, encrypted security questions; and (6) encrypting, by the processor, by the centralized server, the encrypted data received from the user using the centralized server encryption key.

In another embodiment, a computer-based system is configured for a method of restoring the wallet private keys to and from a centralized system. The computer-based system includes a user device (for example, mobile phone, tablet, PC, etc.) and a server with storage (for example, a database). The method includes (1) requesting, by the user device using network interface, encrypted private key, encrypted password to the private key, encrypted security questions; (2) validating, by the processor, by the centralized server, that the user is authorized to get the data and decrypting the backup data with the centralized server encryption key; (3) sending, by the processor using network interface, encrypted private key, encrypted password to the private key, encrypted security questions from the centralized server to the user device; (4) decrypting, by the processor, by the user device, the security questions using the encryption key based on the combination of personal data (for example: SSN, account number, driver's license, etc.); (5) decrypting, by the processor, by the user device, private key password using the encryption key based on the answers to security questions; and (6) decrypting, by the processor, by the user device, the private key using the password.

In another embodiments, a computer-based system configured for payments using the hybrid architecture of a centralized payment system and cryptographically secure distributed ledger described in claim 3 in use together with the methods for reaching consensus between computing devices to accept or reject the transaction from claim 5 and the methods to securely backup and restore the wallet private keys to/from the centralized system from claims 6 and 7. in support of the methods of the previously disclosed embodiments.

In another embodiment, a computer-based system includes a memory; a network interface; an input/output (I/O) interface; a processor (communicating with the memory, network interface and the I/O interface. The computer-based system is configured to perform a method including (1) accessing the memory where sender's or receiver's balance chain or other date is stored; (2) generating a transaction when the sender submits a command using I/O interface to initiate a payment and the receiver accepts the payment; (3) exchanging data between network nodes using a network interface; (4) sending and receiving the payments; (5) processing and validating the transactions and reaching consensus by validating nodes; (6) depositing and withdrawing of the fiat currency; and (7) completing backup and/or restore of the private key in support of the methods of the previously disclosed embodiments.

The features and advantages described in this summary and the following detailed description are not all-inclusive. Many additional features and advantages will be apparent to one of ordinary skill in the art in view of the drawings, specification, and claims presented herein.

### BRIEF DESCRIPTION OF THE DRAWINGS

The present embodiments are illustrated by way of example and are not intended to be limited by the figures of the accompanying drawings. In the drawings:

FIG. 1 depicts a diagram illustrating system and methods for payments using the hybrid architecture of centralized payment system and cryptographically secure distributed ledger . . . in accordance with embodiments of the present disclosure.

FIG. 2 depicts a diagram illustrating a Confidential Multi-Chain structure where each chain represents an individual account and tracks balance changes with privacy in accordance with embodiments of the present disclosure.

FIG. 3 depicts a diagram illustrating the method to validate that the account has at least s amount of coins without knowing the exact amount in accordance with embodiments of the present disclosure.

FIG. 4 depicts a diagram illustrating a system and method to solve the described security issues in accordance with embodiments of the present disclosure.

FIG. 5 depicts a cost effective system and methods to deposit and withdraw fiat currency into and from the system with conversion to digital assets in accordance with embodiments of the present disclosure.

FIG. 6 depicts a diagram illustrating a Long Stake consensus system and methods to provide zero-cost and instant settlement for on-chain transactions with privacy in accordance with embodiments of the present disclosure.

FIG. 7 depicts a diagram illustrating the system with end to end flow for cost effective payments with high security in accordance with embodiments of the present disclosure.

FIG. 8A depicts a diagram illustrating the system and methods to securely backup the wallet private keys to the centralized system in accordance with embodiments of the present disclosure.

FIG. 8B depicts a diagram illustrating the system and methods to securely restore the wallet private keys from the centralized system in accordance with embodiments of the present disclosure.

FIG. 9 depicts a diagram illustrating an example of a computing device to send/receive payments, deposit/withdraw the fiat currency, reach consensus between computing nodes, backup/restore the private key, process and validate a payment transaction in accordance with embodiments of the present disclosure.

### DETAILED DESCRIPTION

The present disclosure presents embodiments for solving the technological problem of security within centralized payment systems by using hybrids of cryptographically secure distributed ledger technologies and centralized payment systems.

The system combines the benefits of a centralized system, including the ability to deposit and withdraw fiat currency following bank regulations, including Know Your Customer” (KYC) and “Anti-Money Laundering” (AML) rules, with high security of cryptographically secure distributed ledger technology. Existing solutions do not provide the same level of security. Also, disclosed is a Confidential Multi-chain structure for implementing the methods with (or without) privacy and scalability. As such the embodiment provide for cost effective deposit/withdraw of fiat currency into/from the system with conversion to digital assets. Also the embodiments disclose a Long Stake consensus system and methods to provide zero-cost and instant settlement for on-chain transactions with privacy. These embodiments further describe how to securely backup and restore the wallet private keys to/from the centralized system for better usability. The methods of the embodiments may be implemented entirely as a hardware component, for example as a specialized circuit(s), entirely as a software component or a combination of both.

The following description and figures are illustrative and are not to be construed as limiting. Numerous specific details are described to provide a thorough understanding of the disclosure. However, in certain instances, well-known or conventional details are not described in order to avoid obscuring the description. References to “one embodiment” or “an embodiment” in the present disclosure can be, but not necessarily are, references to the same embodiment and such references mean at least one of the embodiments.

Reference in this specification to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not for other embodiments.

The terms used in this specification generally have their ordinary meanings in the art, within the context of the disclosure, and in the specific context where each term is used. Certain terms that are used to describe the disclosure are discussed below, or elsewhere in the specification, to provide additional guidance to the practitioner regarding the description of the disclosure. For convenience, certain terms may be highlighted, for example using italics and/or quotation marks. The use of highlighting has no influence on the scope and meaning of a term; the scope and meaning of a term is the same, in the same context, whether or not it is highlighted. It will be appreciated that same thing can be said in more than one way.

Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification, including examples of any terms discussed herein, is illustrative only, and is not intended to further limit the scope and meaning of the disclosure or of any exemplified term. Likewise, the disclosure is not limited to various embodiments given in this specification.

Without intent to limit the scope of the disclosure, examples of instruments, apparatus, methods and their related results according to the embodiments of the present disclosure are given below. Note that titles or subtitles may be used in the examples for convenience of a reader, which in no way should limit the scope of the disclosure. Unless otherwise defined, all technical and scientific terms used herein have the same meaning as commonly understood by one of ordinary skill in the art to which this disclosure pertains. In the case of conflict, the present document, including definitions, will control.

Traditional centralized payment systems are vulnerable to multiple types of attacks that compromise their security. Seven examples of these types of attack are disclosed In a first type of attack, an attacker contacts the phone provider and, by pretending to be the phone number owner, asks to port the number to his subscriber identification module (SIM). Then the attacker is able to reset the password to the payment application overcoming 2-factor authentication, like reading short message service (SMS) and can spend other person's money

In a second type of attack, an attacker steals mobile device, overcomes 2-factor authentication and after successful reset password procedure can spend other person's money. 2-factor authentication like SMS and email may not work well as person with access to the phone usually has access to read SMS and access to email client without the need to enter additional password.

In a third type of attack, an attacker steals mobile device, overcomes security questions, and after successful reset password procedure can spend other person's money (security questions may not be secure enough, as attacker can use the person's social media profiles to figure out the answers).

In a fourth type of attack, an attacker gains access to the mobile device where payment application is secured by application password and biometric data validations, overcomes 2-factor authentication (same as the second and third types of attacks), and gains the access to the payment system database to disable biometric data validations. As a result the attacker can spend the person's money.

In a fifth type of attack, an attacker gains the access to the database and changes the balance (or other data) in a way that will be unnoticeable to the system

In a sixth type of attack, an attacker gains the access to the databases and destroys the data including the back ups

In a seventh type of attack, an attacker gains the access to Customers and Merchants balances and other data.

This disclosure provides methods, systems, and devices for solving the technological problem of security within centralized payment systems (including the previously disclosed attacks) using hybrids of cryptographically secure distributed ledger technologies and centralized payment systems.

These methods, devices, and systems combine the benefits of a centralized system, including the ability to deposit and withdraw fiat currency following bank regulations, KYC, AML, with security of cryptographically secure distributed ledger technology to solve security issues.

Disclosed is a cost effective payment system, which includes the cost effective system and methods to deposit and withdraw fiat currency into the system with conversion to digital assets with the combination of a proprietary Confidential Multi-Chain distributed ledger technology with Long Stake consensus to provide zero-cost, instant settlement, privacy and scalability for on-chain transactions. This disclosure provides improved the security of payments, including payments from mobile devices, and at the same time to provide cost efficient payment solution and good user experience.

Details of the specific distributed ledger implementation, data structures and transaction flows are disclosed herein, however, it is to be understood that these are merely examples and specific structural and functional details should not be interpreted as limiting but rather should help to understand the concept and serve as the basis of the claims.

It is to be understood that the methods described below can work and be used with or without on-chain privacy (for example, by not encrypting the balances and transacted amounts in the ledger but using SSL for transport instead), so having the privacy feature should not be interpreted as limiting, but rather as an additional security feature. Also other consensus algorithms and distributed ledger technology can be used, so using specifically Confidential Multi-Chain and Long Stake consensus should not be interpreted as limiting. Also examples below show mostly payments from mobile devices, however, the system and methods apply to any computing device.

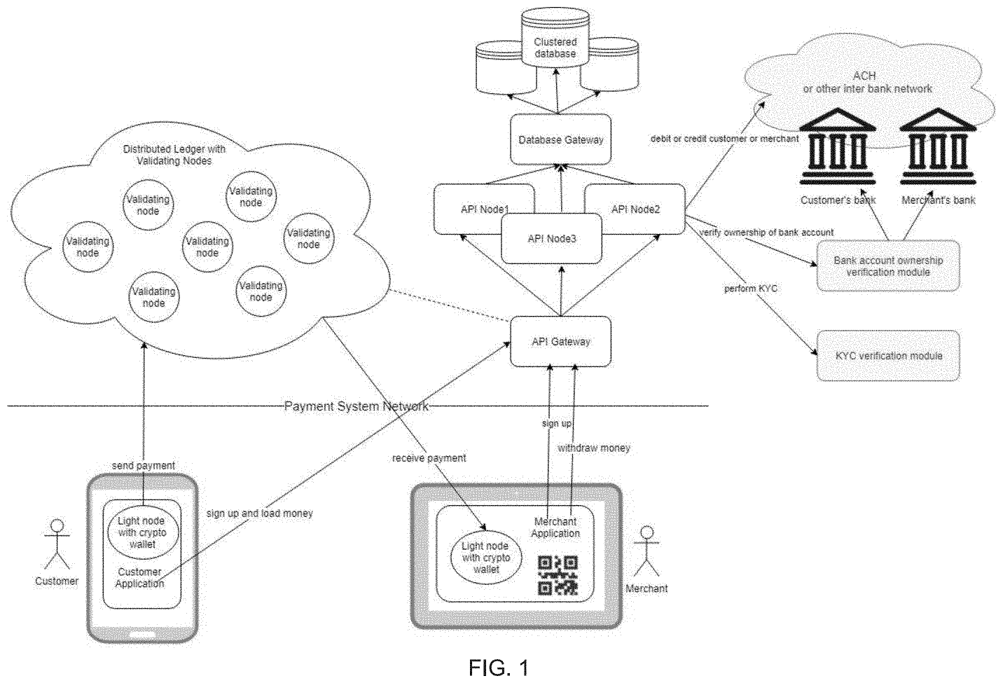

FIG. 1 shows the system and methods for payments using the hybrid architecture of centralized payment system and cryptographically secure distributed ledger. The system consists of API gateway and API nodes that are computing devices that process registration and authentication requests, requests to deposit and withdraw fiat currency, requests for KYC and bank account ownership verification; it consists of a database gateway and a database to store user and application data; it consists of the distributed cryptographically secure ledger that processes the digital assets transactions and stores the balances for each network participant. The mobile and/or desktop application is connecting the Customer and Merchant to the API gateway. The built-in application wallet software is generating the user's pair of the private and public keys and connecting the user to the distributed ledger, where the public key serves as the user wallet address and the private key is kept privately on the user's device and serves to authorize digital assets transfers from the user to the merchant and/or peer to peer transfers. The Customer, buying the product or sending the funds, is signing with the wallet private key the sender's part of the transaction authorizing to spend the digital assets; the Merchant, selling the product or receiving the funds, is signing with its wallet private key the receiver's part of the transaction to authorize acceptance of the digital assets. Then the transaction settles in the distributed ledger when all or majority of individual servers agree to accept or reject it.

API node is connected to KYC verification module to verify the client identity and Bank account ownership verification module to make sure that the person or entity owns the bank account that will be used to deposit and withdraw fiat funds. Also it is connected to the bank API, ACH network or other means to make inter-bank transfers.

Database node is storing user's account data, digital wallet address mapping, and other data necessary to authenticate the user, process account or password recovery requests, perform transactions.

Distributed ledger consists of multiple computing nodes that independently record transactions and balances, then they agree with other nodes if the transaction should be accepted or rejected. Examples of distributed ledgers are blockchains, like Bitcoin, DAGs, Multi-chain structures, etc. Security is achieved by using cryptographic signatures made by the wallet owners holding the private key when they want to participate in transaction, and Merkle tree or hash tree structures where the next block contains the hash of the previous block and modification of a block will invalidate all blocks up to the head of the tree which ensures consistency.

Customer's flow starts with on boarding process, including registration, digital wallet generation and backup, going through KYC procedures, verifying bank account ownership, setting up multi factor authentication which may include biometric data, like fingerprint or face data, and/or pin, depositing funds and receiving digital assets from the system. Then the payments between the Customer and Merchant or peer to peer transfers are done on-chain through the distributed ledger which can be fast, secure and cost efficient.

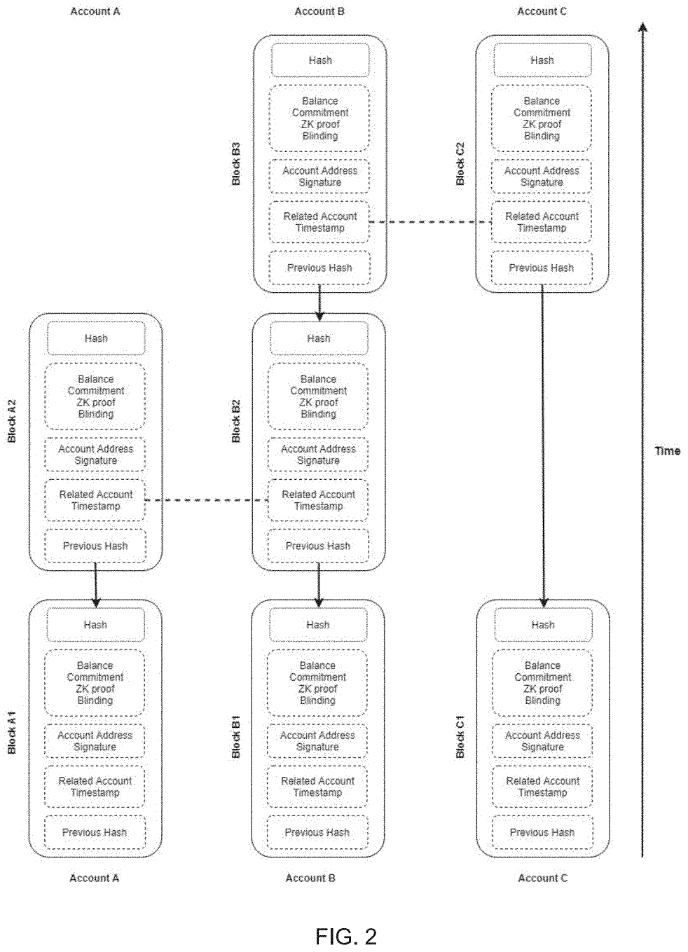

FIG. 2 shows a Confidential Multi-chain structure, which is one example of multi-chain ledger structure where each chain represents an individual account and tracks balance changes, but with privacy. It shows 3 accounts each having an individual chain of blocks. The chain has a sequence of blocks that are linked by means of cryptographic hash function like SHA-2: Previous Hash field of the next block contains the Hash of the previous block. Hash is not required to be stored, it can be calculated dynamically based on the content of the block. Each new block contains the updated total account balance, so the chain can be viewed as the history of balances (and maybe other state fields) where the top block has the actual account balance. Each block has a digital signature made by the account holder using a pair of the holder's private and public keys. Each block has the Account Address which can be the encoded public key. When a transaction between 2 accounts happens, the corresponding 2 chains are linked together, for example by a pair of Related Account and Timestamp fields; this link does not necessarily have a direction but at a minimum means that transaction happened. A lot of variations of the multi-chain block fields are possible, including, but not limited to: the block may have Height and Related Height fields where Height is the block number in the sequence of blocks and Related Height may be used to refer to the block number in the other chain with which transaction happened, or when two blocks are linked with a random number which is the same number in two blocks so that they can be matched, or Timestamp can be an optional field, etc. The block contains a set of fields for privacy, including, but not limited to: Balance, Blinding, Commitment, Zero-knowledge proof Balance contains total account balance. Blinding is a number usually generated as a random number or based on multiple random numbers that help building Commitment and/or Zero-knowledge proof Commitment is a cryptographic primitive that allows one to commit to a chosen value while keeping it hidden to others; examples of commitments are Pedersen Commitment, zk-SNARK commitment, zk-STARK commitment, etc. Zero-knowledge proof is a cryptographic primitive that proves to another party the knowledge of some value without conveying any information apart from the fact that they know the value; examples of zero-knowledge proof protocols are Range Proof, Bulletproof, zk-SNARK, zk-STARK, etc. In one of possible variations of the block structure, the Balance and Blinding fields can be kept only for the head block as these two fields are not part of validation of the previous transactions but are rather needed to construct new block. In the picture we can see that Account A had block A₁, Account B had block B₁, then transaction happened which resulted in construction of new blocks A₂ and B₂ and the link to denote the transaction. The picture also shows the next transaction between Account B and Account C which resulted in construction of blocks B₃ and C₂ and the link between them. It is to be understood that these details should not be interpreted as limiting and the various forms of multi-chain structures or DAG structures with different fields may exist. The key concept is that the block stores the total account balance and each account (or group of accounts) has a separate chain. This data structure enables high scalability when transactions between accounts may happen in parallel.

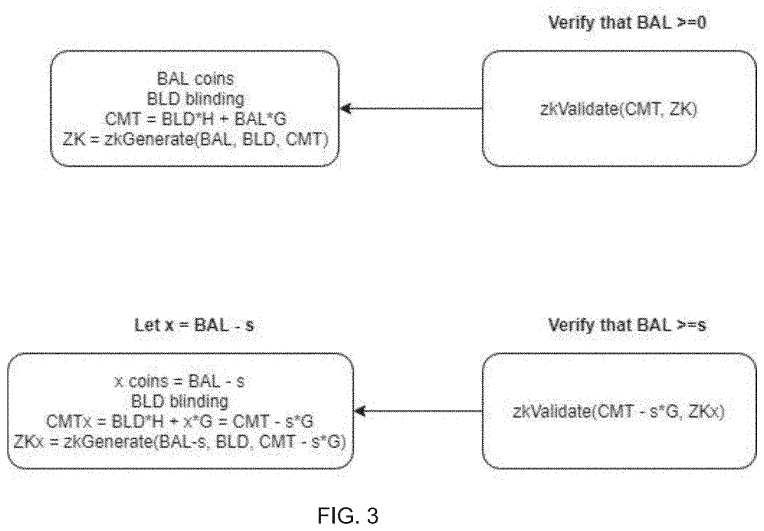

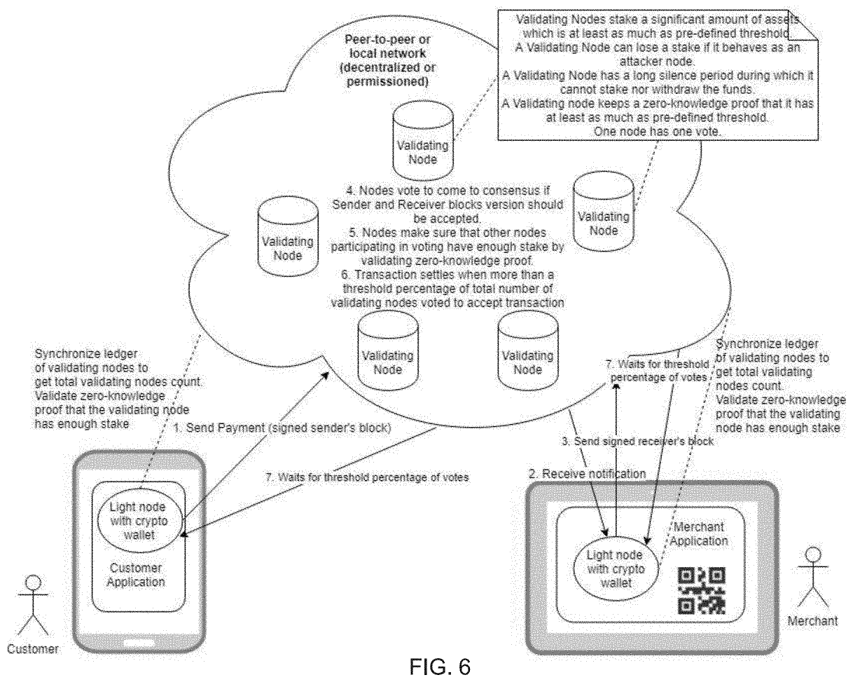

FIG. 3 illustrates the method to validate that the account has at least s amount of coins without knowing the exact amount. As will be shown in the description to FIG. 6, some of the functions rely upon voting of the Validating Nodes, where a Validating Node is a special incentivized network node holding a significant amount of coins. As will be shown in the description to FIG. 6, in the ledger where all the balances are encrypted there is a problem of validating by all network participants that the Validating Node has at least s amount of coins, where this minimum threshold s is predefined by the system. Let BAL and BLD be the balance and block blinding of the Validating Node head block. Then commitment of the block may be calculated as shown in Equation [1].

CMT=BLD*H+BAL*G [1]

Zero-knowledge proof ZK may be calculated as shown in Equation [2]:

ZK=zkGenerate(BAL,BLD,CMT) [2]

One example of such function is a Bulletproof generation function.

It is given that all network participants can validate that BAL is a non-negative number with zero-knowledge proof validation function as shown in Equation [3]

zkValidate(CMT,ZK) [3]

One example of such function is Bulletproof validation function.

Equations [4]-[6] show how to validate that BAL is at least s, meaning that the account has at least s coins. Let x=BAL−s.

CMTₓ=BLD*H+x*G=BLD*H+BAL*G−s*G=CMT−s*G [4]

ZKₓ=zkGenerate(x,BLD,CMTₓ) [5]

ZKₓ=zkGenerate(BAL−s,BLD,CMT−s*G) [6]

To validate that x is a non-negative number, Equation [7] may be used.

zkValidate(CMTₓ,ZKₓ)=zkValidate(CMT−s*G,ZKₓ) [7]

If x is non-negative number that means that BAL is at least s or account has at least s coins.

To summarize, to validate that the account has at least s coins, the account owner should generate zero-knowledge proof as shown in Equation [8]

ZKₓ=zkGenerate(BAL−s,BLD,CMT−s*G) [8]

And all network participants can validate using Equation [9]:

zkValidate(CMT−s*G,ZKₓ) [9]

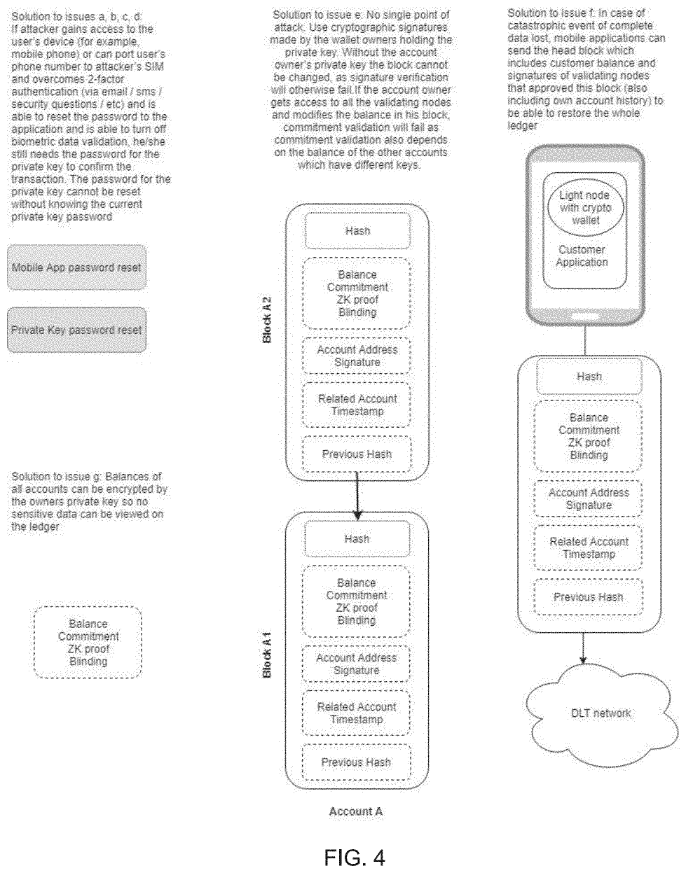

FIG. 4 shows the system and methods to solve the security issues that existing payment systems as related to the previously described seven types of attacks, and are repeated below (A-G) for clarity:
A) Attacker contacts the phone provider and, by pretending to be the phone number owner, asks to port the number to his SIM. Then the attacker is able to reset the password to the payment application overcoming 2-factor authentication, like reading SMS and can spend other person's money
B) Attacker steals mobile device, overcomes 2-factor authentication and after successful reset password procedure can spend other person's money (2-factor authentication like SMS and email may not work well as person with access to the phone usually has access to read SMS and access to email client without the need to enter additional password)
C) Attacker steals mobile device, overcomes security questions, and after successful reset password procedure can spend other person's money (security questions may not be secure enough, as attacker can use the person's social media profiles to figure out the answers).
D) Attacker gains access to the mobile device where payment application is secured by application password and biometric data validations, overcomes 2-factor authentication (same as (b) and (c)), and gains the access to the payment system database to disable biometric data validations. As a result the attacker can spend the person's money.
E) Attacker gains the access to the database and changes the balance (or other data) in a way that will be unnoticeable to the system
F) Attacker gains the access to the databases and destroys the data including the back ups
G) Attacker gains the access to Customers and Merchants balances and other data

Solution for attacks A. B, C, and D: If attacker gains access to the user's device (for example, mobile phone) or can port user's phone number to attacker's SIM and overcomes 2-factor authentication (via email/SMS/security questions/etc.) and is able to reset the password to the application and is able to turn off biometric data validation, he/she still needs the password for the private key to confirm the transaction. The password for the private key cannot be reset without knowing the current private key password.

Solution for attack E: There is no single point of attack in a distributed ledger as each validating node is independently keeping the records and participate in voting with other nodes. Confidential Multi-chain memory structure is using cryptographic signatures made by the wallet owners holding the private key when they want to participate in transaction. So without the account owner's private key the block cannot be changed, as signature verification will otherwise fail. If the account owner gets access to all the validating nodes and modifies the balance in his block, commitment validation will fail as commitment validation also depends on the balance of the other accounts each having its own private key.

Solution for attack F: In case of catastrophic event of complete data lost, application on users devices (such as mobile phones, tablets, PCs, etc.) can send the head block which includes customer balance and signatures of validating nodes that approved this block and also can send account history. This data can be used to restore the whole ledger and/or verify customer's balance.

Solution for attack G: Balances of all accounts can be encrypted by the owners' private keys so that balances cannot be viewed on the ledger. Confidential Multi-chain memory structure stores balance encrypted by the owner's private key and commitments, together with zero-knowledge proofs, are used by validating nodes to validate transactions since validating nodes also cannot view the balances on the ledger.

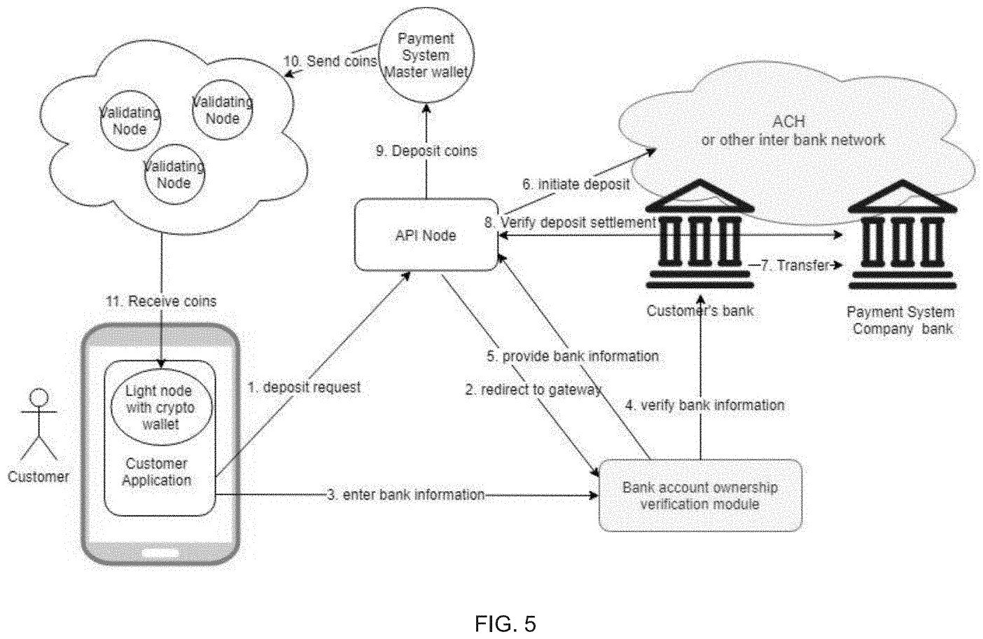

FIG. 5 shows the cost effective system and methods to deposit/withdraw fiat currency into/from the system with conversion to digital assets. The system consists of the user device, API Node which is a server that processes requests, device with Payment System Master wallet program module installed, a network of validating nodes, a module to verify bank account ownership, connection to the bank network via bank API. The Customer, after registration and completing KYC procedure, submits a deposit request and authorization to the API Node from the software installed on his/her device (for example, mobile phone). The API Node redirects the user to the Bank account ownership verification module from where the user can prove the bank account ownership. For example, the user can login to the mobile banking account through the module, and the module can return the account data and handle to the API Node. The API Node, using the Customer bank information, initiates the transfer of fiat currency from the Customer's bank to the Payment System Company bank using ACH network, bank API or other cost effective means. Once the API Node gets notified (or verifies through periodic account check) that the fiat currency settled, it initiates the transfer of digital assets from the Payment System Master wallet to the Customer's digital wallet (installed on his device) through the network of validating nodes. Master wallet sends to the distributed ledger network a data block signed by its private key to initiate transaction. Each validating node individually keeps a record of it and then the block is transferred to the Customer's device. The Customer's device constructs its own block signed by its own private key to be able to accept the funds and sends the block to the validating nodes. Validating nodes vote to accept or reject committing the version of the block pair into the ledger and the digital assets transaction settles. All participants of the transaction are notified. The Customer receives the digital assets equivalent of the transferred fiat currency. Withdrawal of the fiat funds works in the similar way: the user initiates withdrawal and sends digital assets to the master wallet, and the API node submits the equivalent fiat currency transfer from the Payment System company bank to the Customer's bank. Cost efficiency of overall process is achieved by using cost efficient inter-bank transaction (such as ACH transaction or other cost efficient method), waiting for the fiat transaction to settle which ensures the Customer possesses the funds in the bank account, the process of getting funds transfer authorization and bank account ownership verification which minimized the probability of a charge back, using a voting based consensus (instead of higher cost proof-of-work consensus) to settle deposit of digital assets virtually at no cost.

FIG. 6 shows a Long Stake consensus system and methods to provide zero-cost and instant settlement for on-chain transactions with privacy. Existing proof-of-work consensus methods require time and computation power for the nodes to agree to accept transactions. Insofar as I am aware, existing proof-of-stake consensus methods either rely on the knowledge of the account balance or the staking rewards are transaction based. A Long Stake consensus system and methods are disclosed that work when all account balances are encrypted and there are no on-chain transaction fees.

The system includes the users devices (Customer and Merchant device, such as mobile phone, tablet, PC, etc.) and a network of validating nodes. The user device has digital assets wallet software that is communicating with a set of validating nodes via network interface. Validating node has a special program to validate transactions and communicate with other validating nodes to come into agreement which transactions to accept so that each node has the same ledger. To become a validating node, it needs to keep a significant amount of digital assets in its wallet (at least as much as pre-defined threshold) that is locked for a long period of time (for example, 3 months), so that if the node is malicious there will be enough time to detect that. If majority of validating nodes has evidence that the node is malicious then such node will lose a stake. Also, if the node decides to stop being validating and wants to spend digital assets, there will be a long silence period when it cannot vote nor spend digital assets, to prevent the node to misbehave right before spending the digital assets. This adds additional layer of security into the system. The more the minimum balance threshold is to become a validating node, the less chance that a validating node will misbehave and the more costly the attack will be, but it should not be extremely high so that the system may not get enough nodes for fault tolerant consensus.

As all the balances are encrypted, a Validating node needs to keep a zero-knowledge proof that it has at least as much assets as pre-defined threshold. The method from description to FIG. 3 is used to generate such proof and validate by network participants. The method assumes one Validating node has one vote. It is to be understood that there may be other options, for example, when one Validating node may have up to N votes if it has N different zero-knowledge proofs at pre-defined amount levels, or when the voting power increases based on how long the node is staking. If the minimum balance threshold to become a validating node is low, then a node with large amount of assets will have the same voting power (equal to one) as a node with a much lower amount of assets, also the cost of attack will be low—thus the minimum balance threshold is selected to be very high, but not extremely high.

All validating nodes are expected to participate in voting. The Customer and Merchant devices will know if the transaction has settled by getting enough votes (more than the pre-defined threshold percentage of total validating nodes) for the transaction from validating nodes. To do that it first needs to track the number of validating nodes in the system. It needs to download from the distributed ledger the accounts (head block and transaction history) of active validating nodes and also track status changes. Then it needs to validate the zero-knowledge proof from the validating node that it has at least as much assets as the minimum balance threshold by using the method from the description to FIG. 3. The user device can receive individual votes signed with cryptographic signatures from each validating node or can receive a combined message how each validating node voted and based on the rules decide if the transaction has been settled.

Validating nodes use byzantine fault tolerant protocol to achieve consensus if more than the pre-defined threshold percentage of total validating nodes voted to accept the transaction. If there is a certain threshold percentage of malicious nodes, then consensus may not be reached and transaction may get declined. In this case the malicious nodes are determined by the messages they sent (for example, they could vote twice to both accept and reject the transaction, etc.) and their stake can be forfeited (or the ledger can be forked into the new ledger where malicious nodes would be banned).

The method starts with all the nodes and user devices downloading blocks of all validating nodes from the ledger to determine valid validating nodes and the number of votes in the system. One node has one vote. They validate zero-knowledge proofs that the validating nodes have at least as much assets as the minimum balance threshold by using the method from the description to FIG. 3. The Customer sends a payment from his device to the ledger (or peer to peer network connected to the ledger) and the Merchant device get notified that there is a signed sender's block for the transaction, The Merchant confirms the transaction and the signed receiver's block is sent to the ledger. All validating nodes have a sender and receiver pair of blocks which defines a transaction, and the nodes vote to accept or reject it using byzantine fault tolerant protocol. Validating nodes make sure by validating zero-knowledge proof that all voting participants have at least as much assets as the minimum balance threshold. If more than the pre-defined threshold percentage of total validating nodes voted to accept the transaction, Customer and Merchant devices receive the signed votes and consider the transaction has settled.

It is to be understood that the same method can work if the balances are not concealed. The same method can work for both decentralized permissionless and centralized permissioned ledgers. It is to be understood that some parts of the process can be simplified for permissioned network.

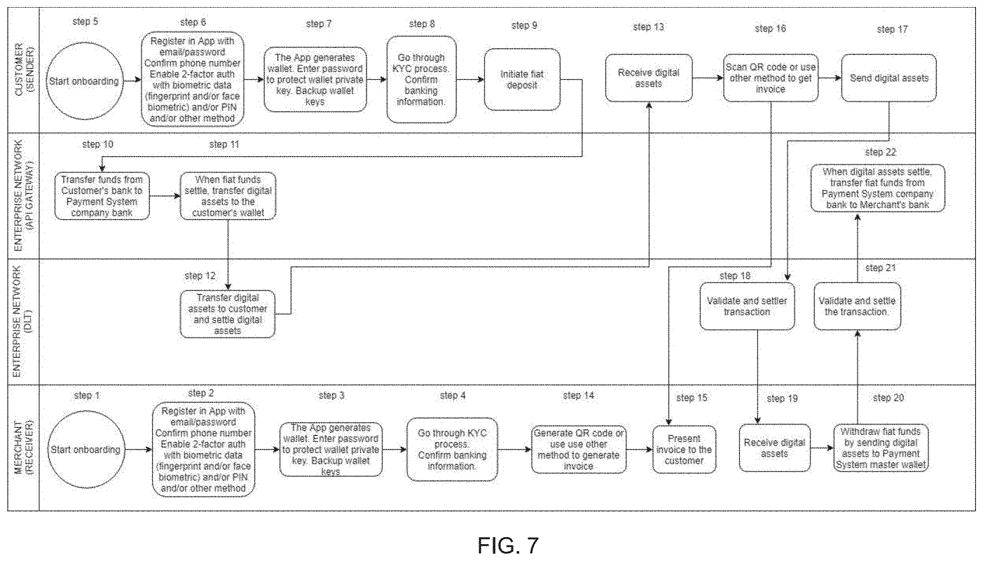

FIG. 7 shows the system with end to end flow for cost effective payments with high security.

In step 1, the Merchant starts on boarding process.

In step 2, the Merchant registers in the application with email and password, confirms the phone number and phone number ownership, enables multi-factor authentication with biometric data (fingerprint and/or face data) and/or PIN and/or other method

In step 3, the application generates digital assets wallet. The Merchant enters password to protect the wallet private key. The Merchant backups the wallet private key.

In step 4, the Merchant goes through KYC process. The Merchant confirms banking information and proves the bank account ownership.

In step 5, the Customer starts on boarding process.

In step 6, the Customer registers in the application with email and password, confirms the phone number and phone number ownership, enables multi-factor authentication with biometric data (fingerprint and/or face data) and/or PIN and/or other method.

In step 7, the application generates digital assets wallet. The Customer enters password to protect the wallet private key. The Customer backups the wallet private key.

In step 8, the Customer goes through KYC process. The Customer confirms banking information and proves the bank account ownership.

In step 9, the Customer initiates deposit of fiat currency.

In step 10, the system transfers funds from the Customer's bank to the Payment System company bank.

In step 11, when fiat currency transfer settles, the API Node initiates transfer of corresponding number of digital assets to the Customer's digital wallet.

In step 12, digital assets transfer happens in the distributed ledger nodes when the nodes reach consensus on the transaction.

In step 13, the Customer gets notified about receiving the digital assets.

In step 14, the Merchant generates QR code or use other method to generate invoice.

In step 15, the Merchant presents invoice to the customer.

In step 16, the Customer scans QR code or use other method to get invoice.

In step 17, the Customer sends digital assets to the Merchant.

In step 18, the distributed ledger nodes validate and settle the transaction.

In step 19, the Merchant gets notified about receiving the digital assets.

In step 20, the Merchant initiates request to withdraw fiat currency. The Merchant sends digital assets to Payment System master wallet.

In step 21, the distributed ledger nodes validate and settle the transaction.

In step 22, the API node transfers fiat currency from the Payment System company bank to the Merchant's bank.

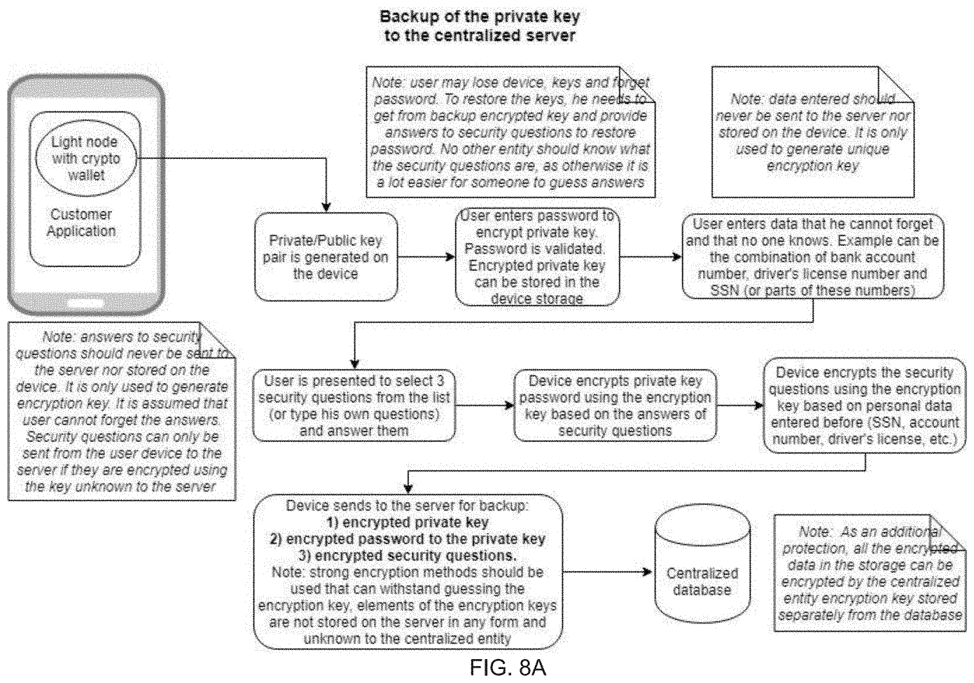

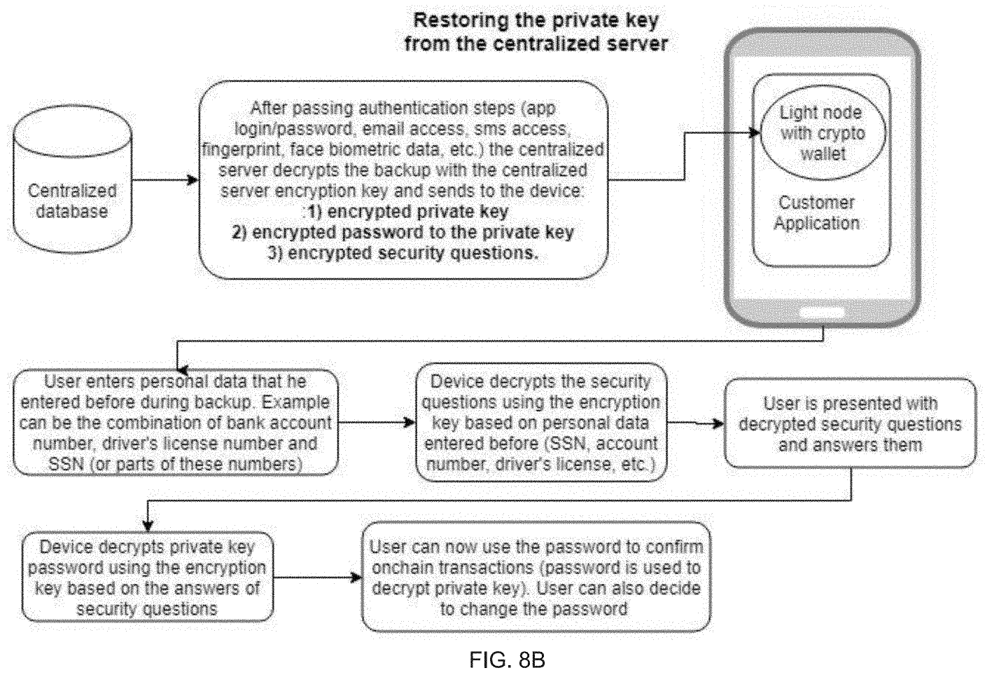

FIG. 8A shows the system and methods to securely backup the wallet private keys to the centralized system. FIG. 8B shows the system and methods to securely restore the wallet private keys from the centralized system. The system includes the user device (mobile phone, tablet, PC, or any other computing device), the server with storage (a database as an example). The user device has a pair of public and private keys generated. The user enters the password to encrypt the private key so that the private key can be stored encrypted in the device storage. The system validates the password.

The problem may occur if the user loses the device and/or loses the keys and/or forgets the password. Existing methods to do backup of the private key include writing down the key itself on the paper, or writing down 12-24 mnemonic words on the paper, or writing down the password, and keeping the paper in a secure location. This is not convenient for majority of people as it requires thinking about at least 2 secure locations to keep the secret.

Disclosed is a the method to backup the private key securely in the centralized trusted storage in a way that if the centralized storage leaks the data (or the database is hacked), it will be computationally infeasible to guess the password to decrypt the private key, assuming the password is strong, and at the same time the user can restore the private key from the backup even if he/she forgets the password.

The method includes the user entering the combination of data that he/she cannot forget and that no one knows. Example can be the combination of bank account number, driver's license number and SSN (or parts of these numbers). Then the user is presented to select 3 security questions from the list (or type his own questions; it is recommended or required to type at least one own question) and the user answers them. It is important that combination of data that user has entered (for example, bank account number, driver's license number and SSN) and the answers to security questions are not sent to the centralized storage nor is stored on the user device. It is also important that the selected/typed security questions can only be sent to the centralized storage encrypted with the key that is not known to the server. It may not be impossible to guess the answers to security questions but it is infeasible to answer the questions without knowing the questions. It is assumed that the user can look up his bank account number, SSN and driver's license number, or other data, and that the user remembers the answers to security questions and they are hard to guess. The user device encrypts private key password using the encryption key based on the answers of security questions. Then the user device encrypts the security questions using the encryption key based on personal data entered before (SSN, account number, driver's license, etc.). Then the user device sends to the centralized storage for backup (1) the encrypted private key, (2) the encrypted password to the private key, and (3) the encrypted security questions

Note: strong encryption methods should be used that can withstand guessing the encryption key, elements of the encryption keys are not stored on the server in any form and unknown to the centralized entity. Key stretching algorithm, like Scrypt, or others, should be used with appropriate parameters to slow down brute-force attack so that it becomes computationally infeasible and strong encryption algorithm, like AES-256 or others, may be used.

Since the centralized entity (or the attacker if the centralized database data leaks) does not know the security questions nor the data used to encrypt the questions, also, as a result, does not know the answers to security questions, it is computationally infeasible to guess the key to decrypt the password or to guess the password to decrypt the private key, assuming that the original password is strong.

As an additional protection, all the encrypted data in the storage can be encrypted by the centralized entity encryption key stored separately from the database. Also the user can get data from the server after passing all the authentication steps, including multi-factor authentication and/or verifying biometric data.

The private key restoration procedure contains the following steps below. After passing authentication steps (application login/password, email access, access to phone to read SMS, fingerprint, face biometric data, etc.) the centralized server decrypts the backup with the centralized server encryption key and sends to the device (1) encrypted private key, (2) encrypted password to the private key, and (3) encrypted security questions.

The user enters personal data that he/she entered before during backup procedure: example can be the combination of bank account number, driver's license number and SSN (or parts of these numbers). The user device decrypts the security questions using the encryption key based on personal data entered before (SSN, account number, driver's license, etc.). The user is presented with decrypted security questions and then the user answers them. The user device decrypts the private key password using the encryption key based on the answers of security questions. The user can now use the password to confirm on-chain transactions (password is used to decrypt the private key). The user can also decide to change the password.

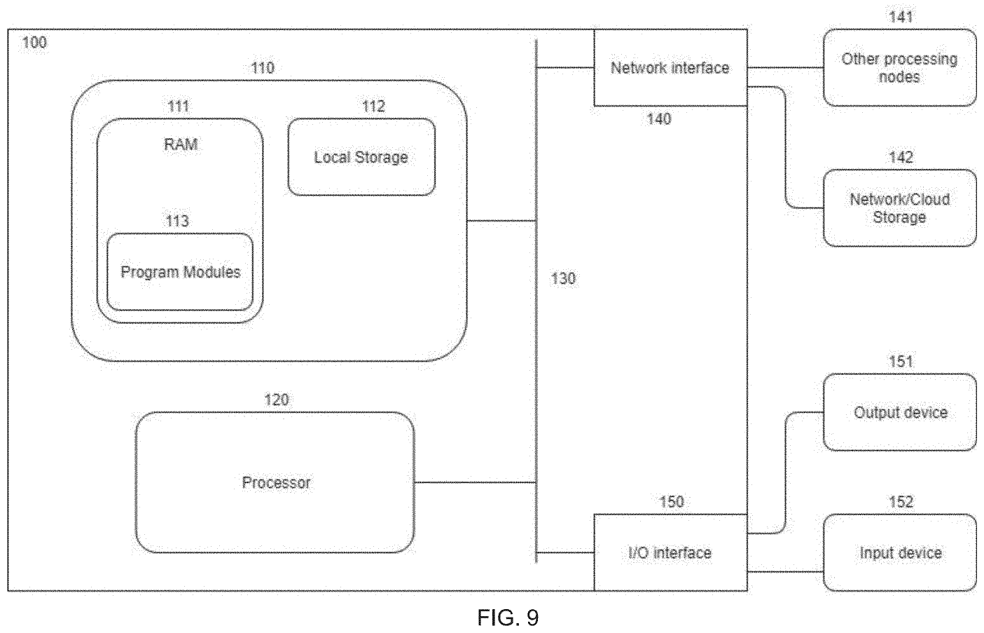

FIG. 9 illustrates one example of a system to implement the subject matter disclosed herein, including sending/receiving payments, depositing/withdrawal of the fiat currency, reaching consensus between computing nodes, backup/restore the private key, processing and validating a payment transaction. It includes computing hardware device 100, which has a processor 120, memory 110, network interface 140, I/O interface 150 and a bus 130 which connects these parts.

The memory 110 may include random access memory (RAM) 111 or any other type of volatile memory, local disk storage 112 including hard disk drive, SSD or any other type of non-volatile memory. Program modules 113 are loaded into RAM which may include Operating System, program data and program executable instructions.

The processor 120 together with the memory 110 implements the data structures and methods described in FIG. 1-8. The described above executable instructions and data are loaded from the local storage 112 into RAM memory 111 and processed by the processor 120. The computer system has I/O interface 150 to read user input from Input device 152 including, but not limited to, keyboard or mouse pointing device or fingerprint reader or face data reader or QR scanner etc., and to display the result on Output device 151 including, but not limited to, monitor or printer.

Network interface 140 is used by the system to communicate with other processing nodes 141 that can participate in transactions or observe and validate them or with network storage devices 142.

The bus 130 links memory 110, processor 120, network interface 140 and I/O interface 150. The bus 130 represents one or more bus structures, including but not limited to, memory bus, local bus, peripheral bus, etc.

It should be understood that the methods defined in the claims and above can be implemented entirely as a hardware component, for example as a specialized circuits, entirely as a software component or a combination of both. It is to be understood that FIG. 9 illustrates one possible implementation and other variations are possible which may include any combination of any hardware components, thus the example should not be considered as limiting.

In conclusion, existing solutions do not provide the advanced level of security to conduct payments while being cost efficient and providing high usability. The disclosed systems, devices, and methods herein provide secure payments using a hybrid of centralized payment system and a cryptographically secure distributed ledger technology. These disclosed technologies combine the benefits of a centralized system, including the ability to deposit and withdraw fiat currency following bank regulations including KYC and AML, with high security of cryptographically secure distributed ledger technology. In support, a Confidential Multi-chain structure is disclosed and used to implement the methods with (or without) privacy and scalability. The systems, devices, and methods provide for cost effective deposit/withdraw of fiat currency into/from the system with conversion to digital assets. A Long Stake consensus system and methods provide zero-cost and instant settlement for on-chain transactions with privacy. Additionally disclosed are methods to securely backup and restore the wallet private keys to/from the centralized system for better usability. The disclosed methods of the claims may be implemented entirely as a hardware component, for example as a specialized circuit(s), entirely as a software component, or a combination of both. These methods form a foundation of the next generation of highly secure and cost efficient payment systems.

As will be appreciated by one skilled in the art, aspects of the present disclosure may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium (including, but not limited to, non-transitory computer readable storage media). A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including object oriented and/or procedural programming languages. Programming languages may include, but are not limited to: Ruby, JavaScript, Java, Python, Ruby, PHP, C, C++, C#, Objective-C, Go, Scala, Swift, Kotlin, OCaml, SAS, Tensorflow, CUDA, or the like. The program code may execute entirely on the user's computer, partly on the user's computer, as a stand-alone software package, partly on the user's computer, and partly on a remote computer or entirely on the remote computer or server. In the latter situation scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described herein with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions.

These computer program instructions may be provided to a processor of a general purpose computer, special purpose computer, or other programmable data processing apparatus to produce a machine, such that the instructions, which execute via the processor of the computer or other programmable data processing apparatus, create an ability for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the disclosure. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The disclosure has been presented for purposes of illustration and description, but is not intended to be exhaustive or limited in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-based system configures for payments using a hybrid architecture of a centralized payment system and a cryptographically secure distributed ledger technology, the computer-based system comprising:
a centralized database;
a distributed ledger;
application programming interfaces (API) servers;
users' devices including customer devices and merchant devices, and
a master wallet device, wherein the computer-based system is configured for:
registering, by the processor, by the user device and by the connected API node/server, in the device application by capturing the input from the user such as the email and application password, the phone number, multi-factor authentication (such as biometric data, pin, etc.), and processing the data;
generating, by the processor, by the user device, a pair of public/private keys for the digital wallet;
encrypting, by the processor, by the user device, the private key with the wallet password, entered by the user, and, optionally, securely backup the private key to be able to restore in case of device lost and/or forgetting the password;
connecting, by the processor and network interface, to a “Know Your Customer” (KYC) verification sub-system to verify the client identity;
connecting, by the processor and network interface, to a bank account ownership verification sub-system to confirm a person or entity owns the bank account that will be used to deposit and withdraw fiat currency;
processing, by the processor, by the API node, the customer's fiat currency deposit request by using the bank API or automated clearing house (ACH) network to make inter-bank transfers;
processing, by the processor, by the API Node, distributed ledger, user device and master wallet device, the transfer of digital assets from the payment system master wallet to the client wallet;
generating an invoice, by the processor, by the merchant's device, for the customer to pay, by generating a quick response (QR) code;
generating a customer's part of the transaction, by the processor, by the customer's device, by processing the invoice, getting the merchant's wallet address, amount to pay and other data, creating the sender block and signing by the wallet private key and sending to the distributed ledger;
generating the Merchant's part of the transaction, by the processor, by the Merchant's device, by creating the receiver block and signing by the wallet private key to accept the incoming transfer and sending to the distributed ledger;
processing, by the processor, by individual servers in distributed ledger the transaction and agree with other servers to accept or reject it;
processing, by the processor, by the API node, the client's fiat currency withdrawal request by using the bank API, or the ACH network to make inter-bank transfers; and
processing, by the processor, by the API Node, distributed ledger, user device and master wallet device, the transfer of digital assets from the client wallet to Payment System master wallet.

2. The computer-based system of claim 1 further comprising:
a memory; and
a set of chains stored in the memory, where each chain represents an individual account and tracks balance changes, wherein the set of chains provide a Confidential Multi-chain computer-based memory structure for computing nodes in the distributed ledger.

3. The computer-based system of claim 2, wherein the method further includes:
verifying, by the processor, by the validating node, the signatures of all transaction data blocks, to make sure data has not been changed by the attacker;
verifying, by the processor, by the validating node, all commitment values and zero-knowledge proofs, to make sure that the attacker did not change the balances;
concealing the balances, by the processor, by the user device using the user private keys; and
sending, by the processor and network interface, by the user device the account head block with account history to the server to restore the whole ledger and/or verify customer's balance, for example in case of catastrophic event of complete data lost on the server.
